(19) United States
(12) Patent Application Publication
(10) Pub. No.: US 2026/0223011 A1
(43) Pub. Date: Jul. 30, 2026

(54) METHOD AND APPARATUS FOR TRANSMITTING POWER HEADROOM REPORT, AND READABLE STORAGE MEDIUM

(71) Applicant: Beijing Xiaomi Mobile Software Co., Ltd., Beijing (CN)

(72) Inventor: Shengxiang GUO, Beijing (CN)

(73) Assignee: Beijing Xiaomi Mobile Software Co., Ltd., Beijing (CN)

(21) Appl. No.: 19/142,502

(22) PCT Filed: Dec. 26, 2022
(86) PCT No.: PCT/CN2022/142026

§ 371 Date: Jun. 23, 2025

(51) Int. Cl. H04W 52/36

(52) U.S. Cl. CPC H04W 52/365; H04W 52/367

(57) ABSTRACT

The present disclosure provides a method and apparatus for transmitting a power headroom report (PHR), and a readable storage medium. The method includes: sending a PHR to a network device, the PHR comprising the average power headroom of the specific absorption rate (SAR) PHR_{SAR} of a user equipment, and the PHR_{SAR} being determined according to an average uplink transmission power value within a first time period and an SAR threshold value.

### CROSS-REFERENCE TO RELATED APPLICATIONS

The present application is a National Stage of International Application No. PCT/CN2022/142026, filed on Dec. 26, 2022, the entire disclosure of which is incorporated herein by reference for all purposes.

### TECHNICAL FIELD

The present disclosure relates to the field of wireless communication technology, and in particular to a method, an apparatus for transmitting a power headroom report, and a readable storage medium.

### BACKGROUND

The coverage area of Uplink Coverage or Downlink Coverage directly affects the Quality of Service (QoS), Capital Expenditure (CAPEX) and Operating Expense (OPEX) of operators, so the coverage area is an important factor that operators need to consider when deploying commercial cellular wireless communication systems. Compared with the 4G long term evolution (LTE) system, the 5G New Radio (NR) system uses a higher spectrum, so the path loss of uplink and downlink will also be greater, which brings greater challenges to the coverage of the 5G system, especially for the uplink coverage from the user equipment (UE) to the base station.

In the related technologies that consider the impact of electromagnetic radiation on human body safety, when the UE detects that a human body is approaching, it will perform a certain power reduction to meet the requirements of the Specific Absorption Rate (SAR) or Maximum Permissible Exposure (MPE). The power reduction operation of UE will cause the uplink coverage capability to deteriorate. The problem of the impact of UE on uplink coverage in the process of meeting human body safety needs to be solved.

### SUMMARY

The present disclosure provides a method, an apparatus for transmitting a power headroom report, and a readable storage medium.

In a first aspect, the present disclosure provides a method for sending a power headroom report, performed by a user equipment, the method including:
sending a power headroom PHR report to a network device, wherein the PHR report includes a Specific Absorption Rate Average Power Headroom PHR_{SAR} of the user equipment, the PHR_{SAR} is determined according to an average value of uplink transmission power in a first time period and an SAR threshold value.

In a second aspect, the present disclosure provides a method for receiving a power headroom report, performed by a network device, the method including:
receiving a PHR report sent by a user equipment, wherein the PHR report includes a Specific Absorption Rate Average Power Headroom PHR_{SAR} of the user equipment, the PHR_{SAR} is determined according to an average value of uplink transmission power in a first time period and an SAR threshold value;
scheduling an uplink transmission parameter of the user equipment according to the PHR report.

In a third aspect, the present disclosure provides an apparatus for sending a power headroom report, which can be used to execute the steps executed by the user equipment in the first aspect or any possible design of the first aspect. The user equipment can implement each function in the above methods in the form of a hardware structure, a software module, or a hardware structure in combination with a software module.

In a fourth aspect, the present disclosure provides an apparatus for receiving a power headroom report, which can be used to execute the steps executed by the network device in the second aspect or any possible design of the second aspect. The network device can implement each function in the above methods in the form of hardware structure, software module, or a hardware structure in combination with a software module.

In a fifth aspect, the present disclosure provides a communication apparatus, including a processor and a memory, wherein the memory is configured to store a computer program; the processor is configured to execute the computer program to implement the method according to the first aspect or any possible design of the first aspect.

In a sixth aspect, the present disclosure provides a communication apparatus, including a processor and a memory, wherein the memory is configured to store a computer program; the processor is configured to execute the computer program to implement the method according to the second aspect or any possible design of the second aspect.

In a seventh aspect, the present disclosure provides a non-transitory computer-readable storage medium, having instructions (or computer programs, programs) stored therein, wherein when the instructions are invoked for execution on a computer, the computer is enabled to implement the method according to the first aspect or any possible design of the first aspect.

In an eighth aspect, the present disclosure provides a non-transitory computer-readable storage medium, having instructions (or computer programs, programs) stored therein, wherein when the instructions are invoked for execution on a computer, the computer is enabled to implement the method according to the second aspect or any possible design of the second aspect.

It should be understood that the above general description and the following detailed description are exemplary and explanatory only, and do not limit the present disclosure.

### BRIEF DESCRIPTION OF THE DRAWINGS

The accompanying drawings illustrated herein are used to provide a further understanding of the embodiments of the present disclosure and form a part of the present application, and the schematic embodiments of the present disclosure and their illustrations are used to explain the embodiments of the present disclosure and do not constitute an undue limitation of the embodiments of the present disclosure. In the accompanying drawings:

The accompanying drawings herein, which are incorporated into and form a part of the specification, illustrate embodiments consistent with embodiments of the present disclosure, and are used with the specification to explain the principles of embodiments of the present disclosure.

FIG. 1 is a schematic diagram of a wireless communication system architecture provided by an embodiment of the present disclosure;

FIG. 2 is a flow chart of a method for transmitting a power headroom report according to an example embodiment;

FIG. 3 is a schematic diagram of an SAR average power headroom according to an example embodiment;

FIG. 4 is a flow chart of a method for sending a power headroom report according to an example embodiment;

FIG. 5 is a flow chart of a method for sending a power headroom report according to another example embodiment;

FIG. 6 is a flow chart of a method for sending a power headroom report according to another example embodiment;

FIG. 7 is a flow chart of a method for receiving a power headroom report according to an example embodiment;

FIG. 8 is a flow chart of a method for receiving a power headroom report according to another example embodiment;

FIG. 9 is a flow chart of a method for receiving a power headroom report according to another example embodiment;

FIG. 10 is a block diagram of an apparatus for sending a power headroom report according to an example embodiment;

FIG. 11 is a block diagram of a user equipment according to an example embodiment;

FIG. 12 is a block diagram of an apparatus for receiving a power headroom report according to an example embodiment;

FIG. 13 is a block diagram of a communication apparatus according to an example embodiment.

### DETAILED DESCRIPTION

Embodiments of the present disclosure are further described in connection with the accompanying drawings and specific implementations.

Example embodiments will be described in detail herein, examples of which are illustrated in the accompanying drawings. When the following description refers to the drawings, the same numbers in different drawings refer to the same or similar elements unless otherwise indicated. The implementations described in the following example embodiments do not represent all implementations consistent with embodiments of the present disclosure. Rather, they are merely examples of apparatus and methods consistent with aspects of embodiments of the disclosure as detailed in the appended claims.

The terms used in the embodiments of the present disclosure are only for the purpose of describing specific embodiments and are not intended to limit the embodiments of the present disclosure. The singular forms “one” and “the” used in the embodiments of the present disclosure and the attached claims are also intended to include plural forms, unless the context clearly indicates other meanings. It should also be understood that the term “and/or” used herein refers to and includes any or all possible combinations of one or more associated listed items.

It should be understood that although the terms first, second, third, etc. may be used in the embodiments of the present disclosure to describe various information, these information should not be limited to these terms. These terms are only used to distinguish the same type of information from each other. For example, without departing from the scope of the embodiments of the present disclosure, the first information may also be referred to as the second information, and similarly, the second information may also be referred to as the first information. Depending on the context, the words “if” and “in a case that” as used herein may be interpreted as “at . . . ” or “when . . . ” or “in response to determining”.

The embodiments of the present disclosure are described in detail below, and examples of the embodiments are shown in the accompanying drawings, wherein the same or similar reference numerals throughout represent the same or similar elements. The embodiments described below with reference to the accompanying drawings are exemplary and are intended to be used to explain the present disclosure, and cannot be understood as limiting the present disclosure.

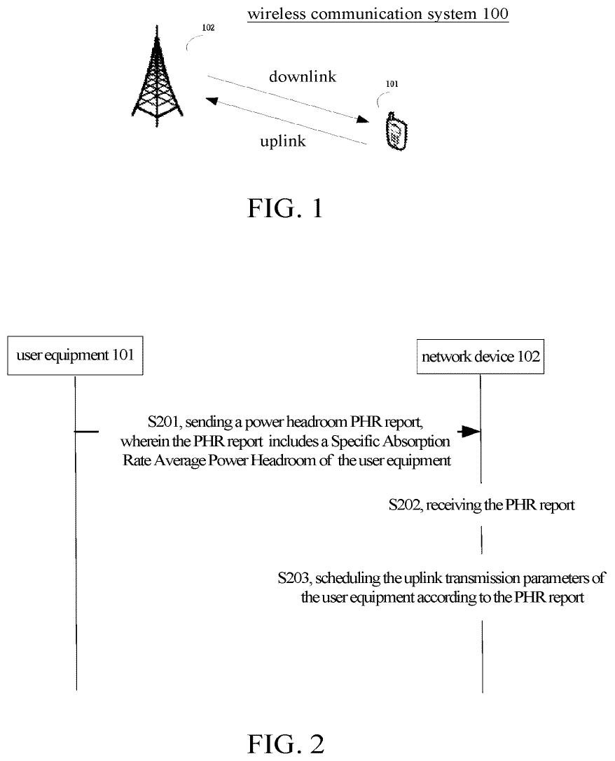

As shown in FIG. 1, the method for transmitting the power headroom report provided by an embodiment of the present disclosure may be applied to a wireless communication system 100. The wireless communication system 100 may include a user equipment 101 and a network device 102. The user equipment 101 is configured to support carrier aggregation and may be connected to a plurality of carrier units of the network device 102, including a primary carrier unit and one or more secondary carrier units.

It should be understood that the above wireless communication system 100 may be applicable to both low-frequency and high-frequency scenarios. The application scenarios of the wireless communication system 100 include, but are not limited to, long term evolution (LTE) systems, LTE frequency division duplex (FDD) systems, LTE time division duplex (TDD) systems, worldwide interoperability for micro wave access (WiMAX) communication systems, cloud radio access network (CRAN) systems, future 5th-Generation (5G) systems, new radio (NR) communication systems, or future evolved public land mobile network (PLMN) systems, and the like.

The user equipment 101 shown above may be a terminal, an access terminal, a terminal unit, a terminal station, a mobile station (MS), a remote station, a remote terminal, a mobile terminal, a wireless communication device, a terminal agent, or a terminal device, etc. The user equipment 101 may have a wireless transceiver function, which is capable of communicating (e.g., wirelessly communicating) with one or more network devices of one or more communication systems, and accepting network services provided by the network devices, which herein include, but are not limited to, the illustrated network device 102.

The user equipment (UE) 101 may be a cellular telephone, a cordless telephone, a session initiation protocol (SIP) telephone, a wireless local loop (WLL) station, a personal digital assistant (PDA) device, a handheld device with wireless communication capabilities, a computing device or other processing device connected to a wireless modem, an in-vehicle device, a wearable device, a terminal device in a future 5G network, or a terminal device in a future evolved PLMN network, and the like.

The network device 102 may be an access network device (or access network site). The access network device refers to a device that has a function of providing network access, such as a radio access network (RAN) base station and the like. The network device 102 may specifically include a base station (BS), or include a base station as well as a wireless resource management device for controlling the base station, and the like. The network device 102 may also include relay stations (relay devices), access points, and base stations in the future 5G network, base stations in the future evolved PLMN network, or NR base stations, and the like. The network device 102 may be a wearable device or an in-vehicle device. The network device 102 may also be a communication chip having a communication module.

For example, the network device 102 includes, but is not limited to, a next-generation base station (gnodeB, gNB) in 5G, an evolved node B (eNB) in a LTE system, a radio network controller (RNC), a node B (NB) in a WCDMA system, a wireless controller under a CRAN system, a base station controller (BSC), a base transceiver station (BTS) in a GSM system or a CDMA system, a home base station (e.g., home evolved nodeB, or home node B, HNB), a baseband unit (BBU), a transmitting and receiving point (TRP), a transmitting point (TP), or a mobile switching center, or the like.

In order to meet the SAR requirements or MPE requirements for human body safety, some user equipments 101 can intelligently adjust the transmission power. For such user equipment 101 that supports intelligent transmission power control capability, it can dynamically control the transmission power and use the time-averaging algorithm to make the transmission power meet requirements of SAR or MPE, thereby meeting the human body safety requirements. For example, the user equipment 101 adjusts the uplink transmission power in real time and dynamically over a period of time, so that the average transmission of the user equipment 101 during the period meets the SAR requirements or MPE requirements. This dynamic power control algorithm is still unknown to the network device 102, that is, the network device 102 cannot know the behavior of the user equipment 101 in performing dynamic power control, and therefore cannot better schedule the uplink transmission of the user equipment 101 to achieve better uplink coverage.

A method for transmitting the power headroom report is provided in the embodiment of the present disclosure. Referring to FIG. 2, FIG. 2 is a method for transmitting the power headroom report according to an example embodiment. As shown in FIG. 2, the method includes steps S201 to S203, specifically:
step S201, the user equipment 101 sends a power headroom PHR report to a network device 102, the PHR report includes a Specific Absorption Rate Average Power Headroom PHR_{SAR} of the user equipment, the PHR_{SAR} is determined according to an average value of uplink transmission power in a first time period and an SAR threshold value.

In some possible implementations, the SAR threshold value is used to characterize the SAR limit value that meets the human body safety requirements. The SAR threshold value is: the uplink transmission power average value allowed for the user equipment 101 in the set time period.

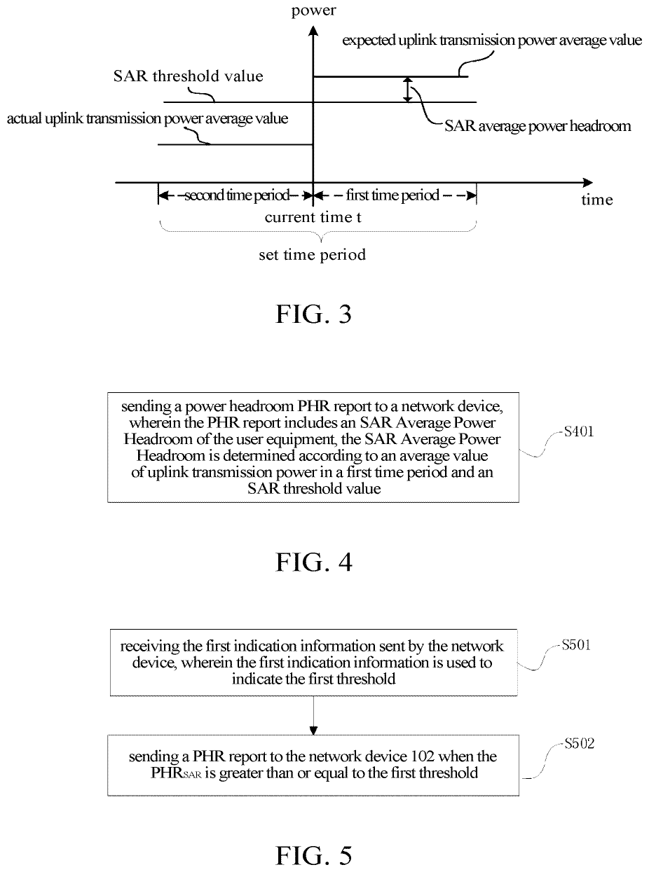

In some possible implementations, in combination with FIG. 3, the set time period includes: a first time period and a second time period. Taking the current time t as the boundary, the second time period is the time period before the current time t, and the first time period is the time period after the current time t.

In some possible implementations, at the current time t, the user equipment 101 can determine the actual uplink transmission power average value in the past second time period, and can determine the relationship between the actual uplink transmission power average value and the SAR threshold value.

In some possible implementations, since the expected uplink transmission power average value and the actual uplink transmission power average value should meet that the uplink transmission power average value in the entire set time period is always less than or equal to the SAR threshold value, the user equipment 101 can determine the uplink transmission power average value allowed in the first time period in the future, i.e., the expected uplink transmission power average value in the first time period, based on the relationship between the actual uplink transmission power average value and the SAR threshold value. The difference between the expected uplink transmission power average value and the SAR threshold value is the SAR average power headroom PHR_{SAR}.

In some possible implementations, the power headroom PHR (recorded as the traditional power headroom PHR in the embodiment of the present disclosure) defined in the relevant protocol can still be reported in the PHR report.

Step S202, the network device 102 receives the PHR report.

Step S203, the network device 102 schedules the uplink transmission parameters of the user equipment 101 according to the PHR report.

In some possible implementations, the uplink transmission parameters include uplink transmission power and/or uplink duty cycle.

In some possible implementations, the network device 102 can determine the uplink transmission power or uplink duty cycle of the user equipment 101 according to the PHR_{SAR}, so as to dynamically schedule the uplink transmission parameters of the user equipment 101 and improve the uplink coverage. The implementation method of determining the uplink transmission parameters by the network device 102 can be referred to the description of the following embodiments.

In the disclosed embodiment, the user equipment reports the SAR average power headroom to the network device through the PHR report, and the network device 102 learns the SAR average power headroom of the user equipment, so that the uplink transmission parameters of the user equipment can be scheduled taking into account the SAR average power headroom, so as to ensure the uplink coverage effect while meeting the human body safety.

In an embodiment of the present disclosure, a method for sending a power headroom report is provided, and the method is executed by a user equipment 101. Referring to FIG. 4, FIG. 4 is a method for sending a power headroom report according to an example embodiment. As shown in FIG. 4, the method includes step S401, specifically:
step S401, the user equipment 101 sends a power headroom PHR report to a network device 102, the PHR report includes a Specific Absorption Rate Average Power Headroom PHR_{SAR} of the user equipment, the PHR_{SAR} is determined according to an average value of uplink transmission power in a first time period and an SAR threshold value.

In some possible implementations, the SAR threshold value is used to characterize the SAR limit value that meets the human body safety requirements. The SAR threshold value is: the uplink transmission power average value allowed for the user equipment 101 in the set time period.

In some possible implementations, in combination with FIG. 3, the set time period includes: a first time period and a second time period. Taking the current time t as the boundary, the second time period is the time period before the current time t, and the first time period is the time period after the current time t.

In some possible implementations, at the current time t, the user equipment 101 can determine the actual uplink transmission power average value in the past second time period, and can determine the relationship between the actual uplink transmission power average value and the SAR threshold value.

In some possible implementations, since the expected uplink transmission power average value and the actual uplink transmission power average value should meet that the uplink transmission power average value in the entire set time period is always less than or equal to the SAR threshold value, the user equipment 101 can determine the uplink transmission power average value allowed in the first time period in the future, i.e., the expected uplink transmission power average value in the first time period, based on the relationship between the actual uplink transmission power average value and the SAR threshold value. The difference between the expected uplink transmission power average value and the SAR threshold value is the PHR_{SAR}.

In some possible implementations, the power headroom PHR (recorded as the traditional power headroom PHR in the embodiment of the present disclosure) defined in the relevant protocol can still be reported in the PHR report.

In some possible implementations, the PHR_{SAR} reported by the user equipment 101 can be applicable to a single-carrier system or a multi-carrier system.

In one example, the PHR_{SAR} reported by the user equipment 101 is applicable to a certain frequency band, a plurality of frequency bands, or all frequency bands in the multi-carrier system.

In one example, in the scenario of the multi-carrier system, the user equipment 101 reports the PHR_{SAR} corresponding to each frequency band respectively.

The multi-carrier system can be Carrier Aggregation (CA) system, a Dual Connectivity (DC) system, or a Muti-RAT Dual Connectivity (MRDC), such as E-UTRAN New Radio Dual Connectivity (EN-DC) and NR eNB Dual Connection (NE-DC), etc.

In the disclosed embodiment, the user equipment 101 reports the SAR average power headroom to the network device 102 through the PHR report, so that the network device 102 can schedule the uplink transmission parameters of the user equipment 101 taking into account the SAR average power headroom, to ensure the uplink coverage effect while meeting human body safety.

In the embodiment of the present disclosure, a method for sending a power headroom report is provided, and the method is executed by the user equipment 101. The method includes step S401′, specifically:
step S401′, the user equipment 101 sends a PHR report to the network device 102 when the PHR_{SAR} is greater than or equal to the first threshold. The PHR report includes a Specific Absorption Rate Average Power Headroom PHR_{SAR} of the user equipment, the PHR_{SAR} is determined according to an average value of uplink transmission power in a first time period and an SAR threshold value.

In some possible implementations, the first threshold PHR_{SAR0} may be set or determined by the user equipment 101.

In some possible implementations, the first threshold may be defined by the protocol or configured by the network device 102.

In the embodiment of the present disclosure, when the PHR_{SAR} meets the relevant threshold requirements, for example, PHR_{SAR}>PHR_{SAR0}, the user equipment 101 initiates the reporting of the PHR_{SAR} to the network device 102, and does not need to report when the PHR_{SAR} is less than the first threshold, so as to save signaling.

In the embodiment of the present disclosure, a method for sending a power headroom report is provided, and the method is executed by the user equipment 101. Referring to FIG. 5, FIG. 5 is a method for sending a power headroom report according to an example embodiment. As shown in FIG. 5, the method includes steps S501 to S502, specifically:
step S501, the user equipment 101 receives the first indication information sent by the network device 102, and the first indication information is used to indicate the first threshold.

In some possible implementations, the network device 102 may send the first indication information through downlink control information (DCI).

In some possible implementations, the network device 102 may send the first indication information through radio resource control (RRC) signaling.

Step S502, the user equipment 101 sends a PHR report to the network device 102 when the PHR_{SAR} is greater than or equal to the first threshold. The PHR report includes a Specific Absorption Rate Average Power Headroom PHR_{SAR} of the user equipment, the PHR_{SAR} is determined according to an average value of uplink transmission power in a first time period and an SAR threshold value.

In the embodiment of the present disclosure, the network device 102 configures a first threshold for the user equipment 101, so that the user equipment 101 makes a determination in combination with the first threshold, and when the PHR_{SAR} meets the first threshold requirement, the user equipment 101 initiates the reporting of the PHR_{SAR} to the network device 102.

In the embodiment of the present disclosure, a method for sending a power headroom report is provided, which is executed by the user equipment 101. The method includes step S401″, specifically:
step S401″, when Power Management Maximum Power Reduction P-MPR is greater than or equal to a second threshold, the user equipment 101 sends the PHR report to the network device 102. The PHR report includes a Specific Absorption Rate Average Power Headroom PHR_{SAR} of the user equipment, the PHR_{SAR} is determined according to an average value of uplink transmission power in a first time period and an SAR threshold value.

In some possible implementations, the second threshold P-MPR₀ can be set or determined by the user equipment 101.

In some possible implementations, the second threshold can be defined by the protocol or configured by the network device 102.

In the embodiment of the present disclosure, when the P-MPR meets the relevant threshold requirements, for example, P-MPR>P-MPR₀, the user equipment 101 initiates the reporting of PHR_{SAR} to the network device 102, and does not need to report when the P-MPR is less than the second threshold, so as to save signaling.

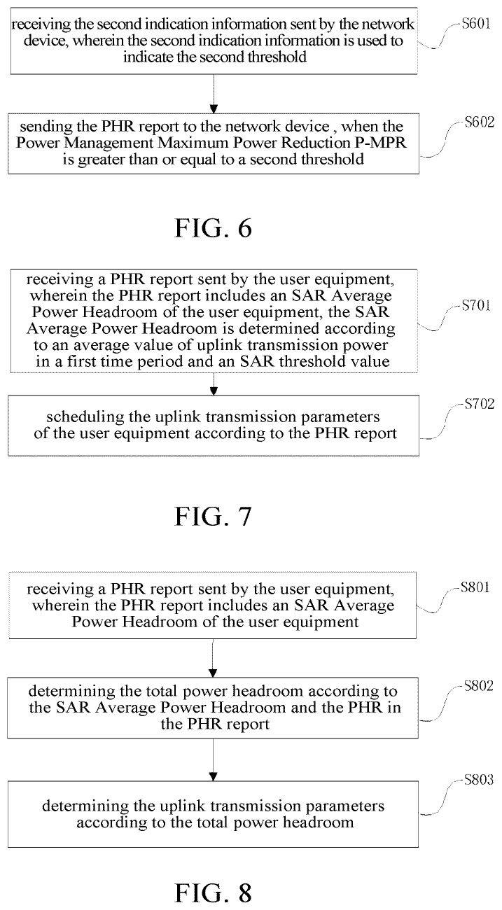

In the embodiment of the present disclosure, a method for sending a power headroom report is provided, which is executed by the user equipment 101. Referring to FIG. 6, FIG. 6 is a method for sending a power headroom report according to an example embodiment. As shown in FIG. 6, the method includes steps S601~S602, specifically:
step S601, the user equipment 101 receives the second indication information sent by the network device 102, and the second indication information is used to indicate the second threshold.

In some possible implementations, the network device 102 may send the second indication information through DCI.

In some possible implementations, the network device 102 may send the second indication information through RRC signaling.

In some possible implementations, the network device 102 may send the first indication information and the second indication information through the same signaling, or send the first indication information and the second indication information respectively through different signaling.

Step S602, when the Power Management Maximum Power Reduction P-MPR is greater than or equal to a second threshold, the user equipment 101 sends the PHR report to the network device 102. The PHR report includes a Specific Absorption Rate Average Power Headroom PHR_{SAR} of the user equipment, the PHR_{SAR} is determined according to an average value of uplink transmission power in a first time period and an SAR threshold value.

In the disclosed embodiment, the network device 102 configures a second threshold for the user equipment 101, so that the user equipment 101 makes a determination in combination with the second threshold, and when the P-MPR meets the second threshold requirement, the user equipment 101 initiates the reporting of the PHR_{SAR} to the network device 102.

In the disclosed embodiment, a method for sending a power headroom report is provided, which is executed by the user equipment 101. The method includes steps S401~S402, specifically:
step S401, the user equipment 101 sends a power headroom PHR report to a network device 102, the PHR report includes a Specific Absorption Rate Average Power Headroom PHR_{SAR} of the user equipment, the PHR_{SAR} is determined according to an average value of uplink transmission power in a first time period and an SAR threshold value.

Step S402, the user equipment 101 sends capability information to the network device 102, the capability information is used to indicate whether the user equipment supports intelligent transmission power control capability.

The execution order of steps S401 and S402 is only for illustration and not limitation. For example, the user equipment 101 may also execute step S402 first, or execute steps S401 and S402 simultaneously.

In some possible implementations, the user equipment 101 indicates whether it supports the intelligent transmission power control capability through 1 bit in the capability information.

In one example, when the 1 bit is 0, it indicates that the user equipment 101 supports the intelligent transmission power control capability.

In one example, when the 1 bit is 1, it indicates that the user equipment 101 does not support the intelligent transmission power control capability.

In some possible implementations, the user equipment 101 that supports the intelligent transmission power control capability can dynamically control the transmission power and use the time-averaging algorithm to make the transmission power meet the requirements of SAR or MPE.

It can be understood that the user equipment 101 that does not support the intelligent transmission power control capability cannot perform dynamic power adjustment, so it may not require dynamic scheduling of the network device 102, nor does it need to report PHR_{SAR}.

In the disclosed embodiment, the user equipment 101 may report capability information to the network device 102, so that the network device 102 may dynamically schedule the uplink transmission parameters of the user equipment 101 that supports the intelligent transmission power control capability, thereby ensuring the uplink coverage effect while meeting the human body safety.

In the disclosed embodiment, a method for sending a power headroom report is provided, which is executed by the user equipment 101. The method includes step S401, specifically:
step S401, the user equipment 101 sends a power headroom PHR report to a network device 102, the PHR report includes a Specific Absorption Rate Average Power Headroom PHR_{SAR} of the user equipment, the PHR_{SAR} is determined according to an average value of uplink transmission power in a first time period and an SAR threshold value.

The PHR report includes an information field for indicating the PHR_{SAR}, and the information field includes several bits.

In some possible implementations, the several bits may be 2 bits, 3 bits, etc.

In some possible implementations, each bit value of the information field is used to indicate the corresponding PHR_{SAR} value, or each bit value of the information field is used to indicate the corresponding PHR_{SAR} range.

In one example, as shown in Table 1, the information field includes 2 bits, and different values of the 2 bits correspond to different PHR_{SAR} values.

TABLE 1

| | PHR_{SAR} |
|---|---|
| Bit | value |
| value | (dB) |
| 00 | 3 |
| 01 | 4 |
| 10 | 6 |
| 11 | 7 |

In one example, as shown in Table 2, the information field includes 3 bits, and different values of the 3 bits correspond to different PHR_{SAR} ranges.

TABLE 2

| Bit value | PHR_{SAR} range (dB) |
|---|---|
| 000 | 0 ≤ PHR_{SAR} < 1 |
| 001 | 1 ≤ PHR_{SAR} < 2 |
| 010 | 2 ≤ PHR_{SAR} < 3 |
| 011 | 3 ≤ PHR_{SAR} < 4 |
| 100 | 4 ≤ PHR_{SAR} < 5 |
| 101 | 5 ≤ PHR_{SAR} < 6 |
| 110 | 6 ≤ PHR_{SAR} < 7 |
| 111 | 7 ≤ PHR_{SAR} |

In the disclosed embodiment, the user equipment 101 indicates a plurality of PHR_{SAR} values or ranges through the information field set in the PHR report. For example, when the bit value corresponding to the information field is different, the corresponding PHR_{SAR} value or range is indicated, so that the network device 102 can obtain the PHR_{SAR} value or range reported by the user equipment 101 according to the information field and perform the scheduling of the corresponding uplink transmission parameters.

In an embodiment of the present disclosure, a method for receiving a power headroom report is provided, and the method is executed by a network device 102. Referring to FIG. 7, FIG. 7 is a method for receiving a power headroom report according to an example embodiment. As shown in FIG. 7, the method includes steps S701 to S702, specifically:
step S701, the network device 102 receives a PHR report sent by the user equipment 101, the PHR report includes a Specific Absorption Rate Average Power Headroom PHR_{SAR} of the user equipment, the PHR_{SAR} is determined according to an average value of uplink transmission power in a first time period and an SAR threshold value.

In some possible implementations, the SAR threshold value is used to characterize the SAR limit value that meets the human body safety requirements. The SAR threshold value is: the uplink transmission power average value allowed for the user equipment 101 in the set time period.

In some possible implementations, the power headroom PHR (recorded as the traditional power headroom PHR in the embodiment of the present disclosure) defined in the relevant protocol can still be reported in the PHR report.

In some possible implementations, the PHR_{SAR} reported by the user equipment 101 can be applicable to a single-carrier system or a multi-carrier system.

For example, the PHR_{SAR} reported by the user equipment 101 is applicable to a certain frequency band, a plurality of frequency bands, or all frequency bands in the multi-carrier system.

Or, in the scenario of the multi-carrier system, the user equipment 101 reports the PHR_{SAR} corresponding to each frequency band respectively.

Step S702, the network device 102 schedules the uplink transmission parameters of the user equipment according to the PHR report.

In some possible implementations, the uplink transmission parameters include uplink transmission power and/or uplink duty cycle.

In some possible implementations, the network device 102 can determine the uplink transmission power or uplink duty cycle of the user equipment 101 according to the PHR_{SAR}, to dynamically schedule the uplink transmission parameters of the user equipment 101 and improve the uplink coverage.

In some possible implementations, when the user equipment 101 reports the PHR_{SAR} applicable to a single frequency band, the network device 102 can schedule the uplink transmission parameters based on the PHR_{SAR} in the frequency band.

In some possible implementations, when the user equipment 101 reports PHR_{SAR} applicable to a plurality of frequency bands, the network device 102 schedules uplink transmission parameters based on the PHR_{SAR} in the plurality of frequency bands respectively.

In some possible implementations, when the user equipment 101 reports the PHR_{SAR} corresponding to each frequency band respectively, the network device 102 schedules the uplink transmission parameters in the frequency band based on the corresponding PHR_{SAR} in each frequency band.

In the disclosed embodiment, the network device 102 receives the PHR report sent by the user equipment 101 to obtain the SAR average power headroom of the user equipment 101, so that the uplink transmission parameters of the user equipment 101 can be scheduled taking into account the SAR average power headroom, so as to ensure the uplink coverage effect while meeting the human body safety.

In the disclosed embodiment, a method for receiving a power headroom report is provided, and the method is executed by the network device 102. Referring to FIG. 8, FIG. 8 is a method for receiving a power headroom report according to an example embodiment. As shown in FIG. 8, the method includes steps S801 to S803, specifically:
step S801, the network device 102 receives a PHR report sent by the user equipment 101, the PHR report includes a Specific Absorption Rate Average Power Headroom PHR_{SAR} of the user equipment, the PHR_{SAR} is determined according to an average value of uplink transmission power in a first time period and an SAR threshold value.

Step S802, the network device 102 determines the total power headroom PHRₜₒₜₐₗ according to the PHR_{SAR} and the PHR in the PHR report.

In some possible implementations, the PHR in the PHR report refers to the traditional power headroom PHR reported by the user equipment 101 according to the relevant protocol.

In some possible implementations, the total power headroom PHRₜₒₜₐₗ=PHR_{SAR}+PHR.

Step S803, the network device 102 determines the uplink transmission parameters according to PHRₜₒₜₐₗ.

In some possible implementations, the uplink transmission parameter includes one of the following:
uplink transmission power;
uplink duty cycle.

In some possible implementations, when the uplink transmission parameter is the uplink transmission power, the network device 102 may determine the uplink transmission power according to PHRₜₒₜₐₗ. For example, the uplink transmission power satisfies that the PHRₜₒₜₐₗ value is added on the basis of the currently configured uplink transmission power. It can be understood that the implementation here is only for illustration and not limitation. The PHRₜₒₜₐₗ obtained according to the PHR_{SAR} and the traditional power headroom PHR in the embodiment of the present disclosure corresponds to the role of the traditional power headroom PHR in the relevant protocol.

In some possible implementations, when the uplink transmission parameter is the uplink duty cycle, step S803 may include the following step S803′, specifically:
step S803′, when an estimated transmission power is greater than a sum of the PHRₜₒₜₐₗ and a maximum configured transmission power, the network device 102 determines the uplink duty cycle according to the PHRₜₒₜₐₗ.

In this implementation, the network device 102 determines the estimated transmission power P_{estimated} according to the current channel environment. For example, the network device 102 estimates the transmission power that the user equipment 101 may need, i.e., the estimated transmission power P_{estimated}, based on the current service type and the minimum signal-to-noise ratio required for the current service type.

In this implementation, the maximum configured transmission power (P_{cmax}) is the maximum transmission power configured by the user equipment 101, and the user equipment 101 can report the P_{cmax} to the network device 102.

In this implementation, the network device 102 schedules the uplink duty cycle when P_{estimated}>PHRₜₒₜₐₗ+P_{cmax}; otherwise, the network device 102 does not need to adjust the uplink duty cycle, and the user equipment 101 still performs uplink transmission according to the duty cycle currently configured by the network device 102 (Dutycycle_{current}).

In one embodiment, determining the uplink duty cycle may include the following steps:
the network device 102 determines determining the uplink duty cycle according to the PHRₜₒₜₐₗ, the maximum configured transmission power, the estimated transmission power, and a configured duty cycle.

The uplink duty cycle is recorded as Dutycycle_{expected}, which satisfies:

$${Dutycycle}_{expected} = {10}^{( ( Pcmax + PHRtotal - Pestimated ) / 10 )} * {Dutycycle}_{current} .$$

It can be understood that, when the uplink duty cycle is small, it indicates that the effective uplink transmission time of the user equipment 101 will be reduced. When the average uplink transmission power in the set time period meeting the human body safety requirements is achieved, a larger uplink transmission power can be used at several times in the set time period. When the uplink duty cycle is large, such as greater than the Maximum Dutycycle Capability, the user equipment 101 will reduce the transmission power level or reduce the transmission power, to meet the human body safety requirements.

In the embodiment of the present disclosure, the network device 102 can determine the uplink transmission power or uplink duty cycle of the user equipment 101 in combination with the relevant information reported by the user equipment 101, so that the uplink transmission parameters of the user equipment 101 can be dynamically scheduled, to maintain the uplink coverage effect on the basis of meeting the human body safety.

The disclosed embodiment provides a method for receiving a power headroom report, which is executed by the network device 102. The method includes steps S701, S701′ and S703, specifically:
step S701, the network device 102 receives a PHR report sent by the user equipment 101, the PHR report includes a Specific Absorption Rate Average Power Headroom PHR_{SAR} of the user equipment, the PHR_{SAR} is determined according to an average value of uplink transmission power in a first time period and an SAR threshold value.

Step S701′, the network device 102 receives capability information sent by the user equipment 101, and the capability information is used to indicate whether the user equipment 101 supports the intelligent transmission power control capability.

Step S702, the network device 102 schedules the uplink transmission parameters of the user equipment according to the PHR report.

The execution order of steps S701 and S701′ is only for illustration and not limitation. For example, the user equipment 101 can also execute step S701′ first.

In some possible implementations, the network device 102 may determine whether the user equipment 101 supports the intelligent transmission power control capability through the corresponding 1 bit value in the capability information.

For example, when the 1 bit is 0, it indicates that the user equipment 101 supports the intelligent transmission power control capability. When the 1 bit is 1, it indicates that the user equipment 101 does not support the intelligent transmission power control capability.

In some possible implementations, the user equipment 101 that supports the intelligent transmission power control capability can dynamically control the transmission power and use the time-averaging algorithm to make the transmission power meet the requirements of SAR or MPE. Therefore, for such user equipment 101, the network device 102 may dynamically schedule the uplink transmission parameters.

In one embodiment, step S702 may include the following step S702′, specifically:
step S702′, when the user equipment supports the intelligent transmission power control capability, the network device 102 schedules the uplink transmission parameters of the user equipment according to the PHR report.

In the disclosed embodiment, the network device 102 learns whether the user equipment 101 supports the intelligent transmission power control capability based on the capability information reported by the user equipment 101, so that the network device 102 can dynamically schedule the uplink transmission parameters of the user equipment 101 that supports the intelligent transmission power control capability, which is more convenient for the network device 102 to schedule the user equipment 101 while better exerting the function of the user equipment 101 to intelligently control the transmission power, so as to better utilize the uplink power of the user equipment 101 under the premise of satisfying human body safety, thereby enhancing the uplink coverage.

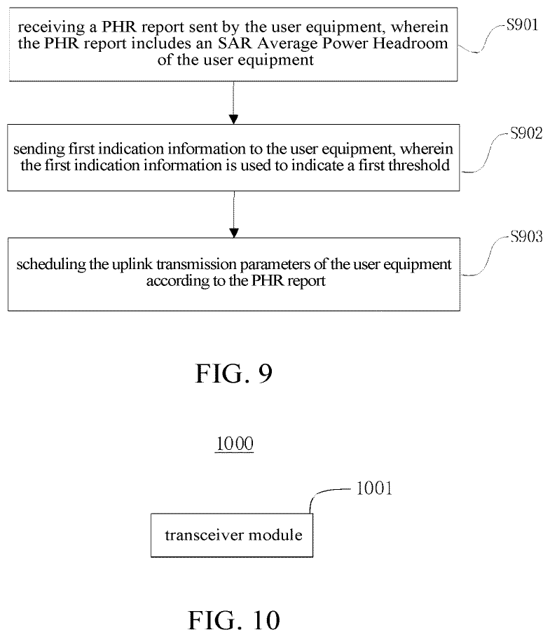

A method for receiving a power headroom report is provided in the disclosed embodiment, and the method is executed by the network device 102. Referring to FIG. 9, FIG. 9 is a method for receiving a power headroom report according to an example embodiment. As shown in FIG. 9, the method includes steps S901 to S903, specifically:
step S901, the network device 102 receives a PHR report sent by the user equipment 101, the PHR report includes a Specific Absorption Rate Average Power Headroom PHR_{SAR} of the user equipment, the PHR_{SAR} is determined according to an average value of uplink transmission power in a first time period and an SAR threshold value.

Step S902, the network device 102 sends first indication information to the user equipment 101, and the first indication information is used to indicate a first threshold.

In some possible implementations, the network device 102 may send the first indication information through DCI.

In some possible implementations, the network device 102 may send the first indication information through RRC signaling.

In step S903, the network device 102 schedules the uplink transmission parameters of the user equipment according to the PHR report.

In the embodiment of the present disclosure, the network device 102 configures the first threshold for the user equipment 101, so that the user equipment 101 initiates the reporting the PHR_{SAR} to the network device 102 when the PHR_{SAR} meets the first threshold requirement.

In the embodiment of the present disclosure, a method for receiving a power headroom report is provided, and the method is executed by the network device 102. The method includes steps S901, S902′ and S903, specifically:
step S901, the network device 102 receives a PHR report sent by the user equipment 101, the PHR report includes a Specific Absorption Rate Average Power Headroom PHR_{SAR} of the user equipment, the PHR_{SAR} is determined according to an average value of uplink transmission power in a first time period and an SAR threshold value.

Step S902′, the network device 102 sends second indication information to user equipment 101, and the second indication information is used to indicate a second threshold.

In some possible implementations, the network device 102 may send the second indication information through DCI.

In some possible implementations, the network device 102 may send the second indication information through RRC signaling.

In some possible implementations, the network device 102 may send the first indication information and the second indication information through the same signaling, or send the first indication information and the second indication information respectively through different signaling.

Step S903, the network device 102 schedules the uplink transmission parameters of the user equipment according to the PHR report.

In the embodiment of the present disclosure, the network device 102 configures the second threshold for the user equipment 101, so that the user equipment 101 initiates reporting the PHR_{SAR} to the network device 102 when the P-MPR meets the second threshold requirement.

Based on the same concept as the above method embodiment, the embodiment of the present disclosure also provides an apparatus for sending a power headroom report, which may have the function of the user equipment 101 in the above method embodiment, and may be used to execute the steps performed by the user equipment 101 provided in the above method embodiment. The function may be implemented by hardware, or by software or by hardware executing the corresponding software. The hardware or software includes one or more modules corresponding to the above function.

In a possible implementation, the apparatus 1000 shown in FIG. 10 can be used as the user equipment 101 involved in the above method embodiment, and execute the steps executed by the user equipment 101 in the above method embodiment. As shown in FIG. 10, the apparatus 1000 may include a c wherein the transceiver module 1001 can be used to support the communication apparatus to communicate.

When executing the steps implemented by the user equipment 101, the transceiver module 1201 is configured to send a power headroom PHR report to a network device 102, the PHR report includes a Specific Absorption Rate Average Power Headroom PHR_{SAR} of the user equipment, the PHR_{SAR} is determined according to an average value of uplink transmission power in a first time period and an SAR threshold value.

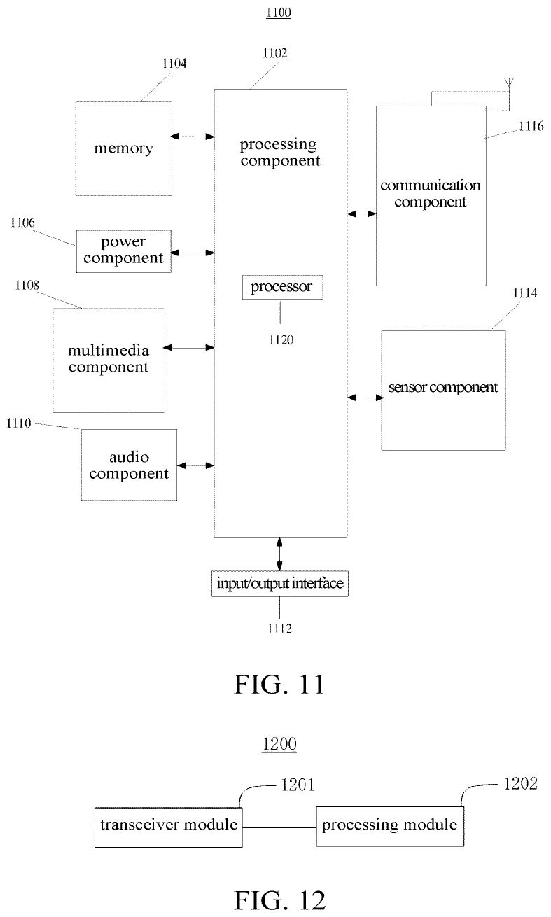

When the apparatus for receiving the configuration information is the user equipment 101, its structure can also be shown in FIG. 11. The apparatus 1100 may be a mobile phone, a computer, a digital broadcast terminal, a messaging device, a game console, a tablet device, a medical device, a fitness device, a personal digital assistant, etc.

Referring to FIG. 11, the apparatus 1100 may include at least one or more of the following components: a processing component 1102, a memory 1104, a power component 1106, a multimedia component 1108, an audio component 1110, an input/output (I/O) interface 1112, a sensor component 1114, and a communication component 1116.

The processing component 1102 typically controls the overall operations of the apparatus 1100, such as the operations associated with display, telephone calls, data communications, camera operations, and recording operations. The processing component 1102 can include one or more processors 1120 to execute instructions to perform all or part of the steps in the above described methods. Moreover, the processing component 1102 can include one or more modules to facilitate the interaction between the processing component 1102 and other components. For example, the processing component 1102 can include a multimedia module to facilitate the interaction between the multimedia component 1108 and the processing component 1102.

The memory 1104 is configured to store various types of data to support the operation of the apparatus 1100. Examples of such data include instructions for any application or method operated on the apparatus 1100, the contact data, the phone book data, messages, pictures, videos, and the like. The memory 1104 can be implemented by any type of volatile or non-volatile storage device, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1106 provides power to various components of the apparatus 1100. The power component 1106 can include a power management system, one or more power sources, and other components associated with the generation, management, and distribution of power for the apparatus 1100.

The multimedia component 1108 includes a screen providing an output interface between the apparatus 1100 and the user. In some embodiments, the screen can include a liquid crystal display (LCD) and a touch panel (TP). If the screen includes the touch panel, the screen can be implemented as a touch screen to receive input signals from the user. The touch panel includes one or more touch sensors to sense touches, swipes, and gestures on the touch panel. The touch sensors may not only sense a boundary of a touch or swipe action, but also detect the duration time and pressure associated with the touch or swipe action. In some embodiments, the multimedia component 1108 includes a front camera and/or a rear camera. When the apparatus 1100 is in an operation mode, such as a photographing mode or a video mode, the front camera and/or the rear camera can receive external multimedia data. Each of the front camera and the rear camera may be a fixed optical lens system or have focus and optical zoom capability.

The audio component 1110 is configured to output and/or input an audio signal. For example, the audio component 1110 includes a microphone (MIC) configured to receive an external audio signal when the apparatus 1100 is in an operation mode, such as a call mode, a recording mode, and a voice recognition mode. The received audio signal may be further stored in the memory 1104 or sent via the communication component 1116. In some embodiments, the audio component 1110 also includes a speaker for outputting the audio signal.

The I/O interface 1112 provides an interface between the processing component 1102 and peripheral interface modules, such as keyboards, a click wheels, buttons, and the like. These buttons may include, but not limited to, a home button, a volume button, a starting button, and a locking button.

The sensor component 1114 includes one or more sensors for providing state assessments of various aspects of the apparatus 1100. For example, the sensor component 1114 can detect an open/closed state of the device 1100, relative positioning of components, such as the display and the keypad of the apparatus 1100. The sensor component 1114 can also detect a change in position of one component of the apparatus 1100 or the apparatus 1100, the presence or absence of user contact with the apparatus 1100, an orientation, or an acceleration/deceleration of the apparatus 1100, and a change in temperature of the apparatus 1100. The sensor component 1114 can also include a proximity sensor configured to detect the presence of nearby objects without any physical contact. The sensor component 1114 can also include a light sensor, such as a CMOS or CCD image sensor, configured to use in imaging applications. In some embodiments, the sensor component 1114 can also include an accelerometer sensor, a gyroscope sensor, a magnetic sensor, a pressure sensor, or a temperature sensor.

The communication component 1116 is configured to facilitate wired or wireless communication between the apparatus 1100 and other devices. The apparatus 1100 can access a wireless network based on a communication standard, such as WiFi, 2G, 3G, or a combination thereof. In an example embodiment, the communication component 1116 receives broadcast signals or broadcast associated information from an external broadcast management system via a broadcast channel. In an example embodiment, the communication component 1116 also includes a near field communication (NFC) module to facilitate short-range communications. For example, the NFC module can be implemented based on radio frequency identification (RFID) technology, infrared data association (IrDA) technology, ultra-wideband (UWB) technology, Bluetooth (BT) technology and other technologies.

In an example embodiment, the apparatus 1100 may be implemented with one or more application specific integrated circuits (ASIC), digital signal processors (DSP), digital signal processing devices (DSPD), programmable logic devices (PLD), field programmable Gate arrays (FPGA), controllers, microcontrollers, microprocessors or other electronic components, to perform the above methods.

In an example embodiment, a non-transitory computer-readable storage medium including instructions is also provided, such as a memory 1104 including instructions, and the above instructions can be executed by the processor 1120 of the apparatus 1100 to complete the above method. For example, the non-transitory computer-readable storage medium can be a ROM, a random access memory (RAM), a CD-ROM, a magnetic tape, a floppy disk, and an optical data storage device.

Based on the same concept as the above method embodiment, the embodiment of the present disclosure also provides an apparatus for receiving a power headroom report, which can have the function of the network device 102 in the above method embodiment, and can be used to perform the steps performed by the network device 102 provided in the above method embodiment. The function can be implemented by hardware, or by software or by hardware executing the corresponding software. The hardware or software includes one or more modules corresponding to the above functions.

In a possible implementation, the communication apparatus 1200 shown in FIG. 12 can be used as the network device 102 involved in the above method embodiment, and perform the steps performed by the network device 102 in the above method embodiment. As shown in FIG. 12, the communication apparatus 1200 may include a transceiver module 1201 and a processing module 1202 that are mutually coupled, wherein the transceiver module 1201 may be used to support the communication apparatus to communicate, and the transceiver module 1201 may have a wireless communication function, for example, it can communicate wirelessly with other communication apparatuses through a wireless air interface. The processing module 1202 may be used for the communication apparatus to perform processing operations, such as generating information/messages that need(s) to be sent, or processing received signals to obtain information/messages.

When executing the steps implemented by the network device 102, the transceiver module 1201 is configured to receive a PHR report sent by the user equipment 101, the PHR report includes a Specific Absorption Rate Average Power Headroom PHR_{SAR} of the user equipment, the PHR_{SAR} is determined according to an average value of uplink transmission power in a first time period and an SAR threshold value.

The processing module 1202 is configured to schedule the uplink transmission parameters of the user equipment according to the PHR report.

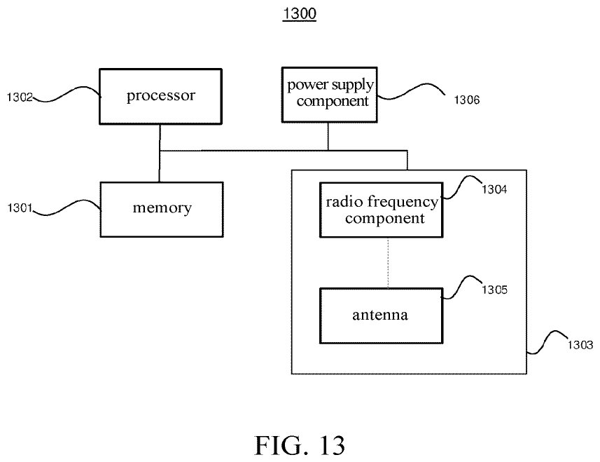

When the communication apparatus is the network device 102, its structure may also be shown in FIG. 13. The structure of the communication apparatus is described by taking a base station as an example. As shown in FIG. 13, the apparatus 1300 includes a memory 1301, a processor 1302, a transceiver component 1303, and a power supply component 1306. The memory 1301 is coupled with the processor 1302, and can be used to store the programs and data necessary for the communication apparatus 1300 to implement various functions. The processor 1302 is configured to support the communication apparatus 1300 to perform the corresponding functions in the above method, and the functions can be implemented by invoking the programs stored in the memory 1301. The transceiver component 1303 can be a wireless transceiver, which can be used to support the communication apparatus 1300 to receive signaling and/or data through a wireless air interface, and to send signaling and/or data. The transceiver component 1303 may also be referred to as a transceiver unit or a communication unit. The transceiver component 1303 may include a radio frequency component 1304 and one or more antennas 1305, wherein the radio frequency component 1304 may be a remote radio unit (RRU), which may be used for transmitting radio frequency signals and converting radio frequency signals with baseband signals, and the one or more antennas 1305 may be used for radiating and receiving radio frequency signals.

When the communication apparatus 1300 needs to send data, the processor 1302 may perform baseband processing on the data to be sent, and then output the baseband signal to the radio frequency unit. The radio frequency unit performs radio frequency processing on the baseband signal and then sends the radio frequency signal through the antenna in the form of electromagnetic waves. When data is sent to the communication apparatus 1300, the radio frequency unit receives the radio frequency signal through the antenna, converts the radio frequency signal to a baseband signal, and outputs the baseband signal to the processor 1302. The processor 1302 converts the baseband signal to data and processes the data.

After considering the specification and practicing the disclosure disclosed herein, those skilled in the art will easily think of other implementation schemes of the disclosed embodiments. The present disclosure is intended to cover any variation, use or adaptive change of the embodiments of the present disclosure, which follows the general principles of the embodiments of the present disclosure and includes common knowledge or conventional technical means in the technical field that are not disclosed in the present disclosure. The description and embodiments are only regarded as exemplary, and the true scope and spirit of the embodiments of the present disclosure are indicated by the following claims.

It should be understood that the embodiments of the present disclosure are not limited to the precise structure described above and shown in the accompanying drawings, and various modifications and changes can be made without departing from the scope thereof. The scope of the embodiments of the present disclosure is limited only by the attached claims.

### INDUSTRIAL APPLICABILITY

According to the method of the present disclosure, the user equipment reports the average power headroom of the SAR to the network device by means of the PHR, and the network device obtains the average power headroom of the SAR of the user equipment, so that uplink transmission parameters of the user equipment can be scheduled taking into account the average power headroom of the SAR. The uplink coverage effect is ensured while human physical safety is met.

1. A method for sending a power headroom report, performed by a user equipment, the method comprising:
sending a power headroom report (PHR) to a network device, wherein the PHR comprises a Specific Absorption Rate Average Power Headroom PHR_{SAR} of the user equipment, the PHR_{SAR} is determined according to an average value of uplink transmission power in a first time period and an SAR threshold value.

2. The method according to claim 1, wherein sending a power headroom report (PHR) to a network device comprises:
sending the PHR to the network device in response to determining that the PHR_{SAR} is greater than or equal to a first threshold.

3. The method according to claim 2, further comprising:
receiving first indication information sent by the network device, wherein the first indication information is used to indicate the first threshold.

4. The method according to claim 1, wherein sending a power headroom report (PHR) to a network device comprises:
sending the PHR to the network device in response to determining that Power Management Maximum Power Reduction (P-MPR) is greater than or equal to a second threshold.

5. The method according to claim 4, further comprising:
receiving second indication information sent by the network device, wherein the second indication information is used to indicate the second threshold.

6. The method according to claim 1, further comprising:
sending capability information to the network device, wherein the capability information is used to indicate whether the user equipment supports intelligent transmission power control capability.

7. The method according to claim 1, wherein the PHR comprises an information field for indicating the PHR_{SAR}, wherein the information field comprises a plurality of bits.

8. The method according to claim 7, wherein each bit value of the information field is used to indicate a corresponding PHR_{SAR} value, or each bit value of the information field is used to indicate a corresponding PHR_{SAR} range.

9. A method for receiving a power headroom report, performed by a network device, the method comprising:
receiving a PHR sent by a user equipment, wherein the PHR comprises a Specific Absorption Rate Average Power Headroom PHR_{SAR} of the user equipment, the PHR_{SAR} is determined according to an average value of uplink transmission power in a first time period and an SAR threshold value; and
scheduling an uplink transmission parameter of the user equipment according to the PHR.

10. The method according to claim 9, wherein scheduling an uplink transmission parameter of the user equipment according to the PHR comprises:
determining a total power headroom PHRₜₒₜₐₗ according to the PHR_{SAR} and power headroom in the PHR; and
determining the uplink transmission parameter according to the PHRₜₒₜₐₗ.

11. The method according to claim 10, wherein the uplink transmission parameter comprises one of the following:
uplink transmission power; and
uplink duty cycle.

12. The method according to claim 11, wherein in a case that the uplink transmission parameter is the uplink duty cycle, determining the uplink transmission parameter according to the PHRₜₒₜₐₗ comprises:
determining the uplink duty cycle according to the PHRₜₒₜₐₗ in response to determining that an estimated transmission power is greater than a sum of the PHRₜₒₜₐₗ and a maximum configured transmission power.

13. The method according to claim 12, wherein determining the uplink duty cycle according to the PHRₜₒₜₐₗ comprises:
determining the uplink duty cycle according to the PHRₜₒₜₐₗ, the maximum configured transmission power, the estimated transmission power, and a configured duty cycle.

14. The method according to claim 9, further comprising:
receiving capability information sent by the user equipment, wherein the capability information is used to indicate whether the user equipment supports intelligent transmission power control capability.

15. The method according to claim 14, wherein scheduling an uplink transmission parameter of the user equipment according to the PHR comprises:
scheduling the uplink transmission parameter of the user equipment according to the PHR, in response to determining that the user equipment supports intelligent transmission power control capability.

16. The method according to claim 9, further comprising:
sending first indication information to the user equipment, wherein the first indication information is used to indicate a first threshold.

17. The method according to claim 9, further comprising:
sending second indication information to the user equipment, wherein the second indication information is used to indicate a second threshold.

18-19. (canceled)

20. A communication apparatus, comprising a processor and a memory, wherein,
the memory is configured to store a computer program, and
the processor is configured to execute the computer program to implement a method for sending a power headroom report, performed by a user equipment, wherein the processor is further configured to:
send a power headroom report (PHR) to a network device, wherein the PHR comprises a Specific Absorption Rate Average Power Headroom PHR_{SAR} of the user equipment, the PHR_{SAR} is determined according to an average value of uplink transmission power in a first time period and an SAR threshold value.

21. A communication apparatus, comprising a processor and a memory, wherein
the memory is used to store a computer program, and
the processor is used to execute the computer program to implement the method according to claim 9.

22. A non-transitory computer-readable storage medium, wherein
instructions are stored in the computer-readable storage medium, the instructions cause a computer to execute the method according to claim 1 when invoked and executed on a computer.

23. (canceled)
